(19) United States
(12) Patent Application Publication
(10) Pub. No.: US 2023/0408628 A1
(43) Pub. Date: Dec. 21, 2023

(54) DETERMINING INDOOR-OUTDOOR CONTEXTUAL LOCATION OF A SMARTPHONE

(71) Applicant: Mobile Physics Ltd., Kfar Saba (IL)

(72) Inventor: Erez WEINROTH, Kfar Saba (IL)

(73) Assignee: Mobile Physics Ltd., Kfar Saba (IL)

(21) Appl. No.: 18/449,832

(22) Filed: Aug. 15, 2023

Related U.S. Application Data
(63) Continuation of application No. PCT/IL2022/050176, filed on Feb. 15, 2022.
(60) Provisional application No. 63/149,376, filed on Feb. 15, 2021.

(51) Int. Cl. G01S 5/02; H04W 4/38; H04W 4/029; G01J 1/42

(52) U.S. Cl. CPC G01S 5/0258; G01J 1/429; H04W 4/029; H04W 4/38

(57) ABSTRACT

Methods and systems are disclosed which determine a location context of a mobile device such as a smartphone. The method may include the following steps: collecting sensor specific data from sensors of the mobile device, applying the sensor specific data to a decision function, and determining, as an output of the decision function, a location context of the mobile device. Also disclosed is a non-transitory computer readable medium containing instructions that when executed causes one or more processors of the mobile device to perform the disclosed method.

This application is a continuation of PCT Application No. PCT/IL2022/050176 filed on Feb. 15, 2022, which claims the priority of U.S. Provisional Patent Application No. 63/149,376 filed on Feb. 15, 2021, both of which are incorporated herein by reference in their entirety.

### FIELD OF THE INVENTION

The present invention relates generally to the field of location determination, and more particularly to determining an indoor-outdoor contextual location of smartphones.

### BACKGROUND OF THE INVENTION

The ability of a smartphone to ascertain whether it is indoors, or outdoors, may be of benefit to the operation of applications, or “apps”, that may be running on the smartphone. Smartphones (herein also “mobile communications devices” or “mobile devices”) already include a variety of sensors such as light sensors, accelerometers, and microphones, to name but a few. Ordinarily, use by apps of this sensor collected data is specific to a task to be achieved: adjustment of a camera app exposure in response to detected light conditions; use of acceleration data for fitness/workout apps etc. Most apps do not require information on whether the smartphone is indoors or outdoors for full functionality. There may be cases however where an app (such as a UV exposure app for monitoring exposure to sunlight, to prevent, for example, sunburn) requires more detailed contextual information as to the location of the smartphone: is the smartphone in a pocket but the user nonetheless in the sun? Is the smartphone indoors? In addition, it may be useful to determine when a user of a smartphone makes a transition from indoors to outdoors, or vice versa.

It is an aim of the present invention to provide contextual location information to apps running on a smartphone.

### SUMMARY OF THE INVENTION

According to some embodiments of the present invention, a method and a system for determining a location context of a mobile device such as a smartphone are provided herein. The method may include the following steps: collecting sensor specific data from sensors of the mobile device, applying the sensor specific data to a decision function, and determining, as an output of the decision function, a location context of the mobile device. Also disclosed is a non-transitory computer readable medium containing instructions that when executed causes one or more processors of the mobile device to perform the disclosed method.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram showing an exemplary architecture of a mobile communications device;

FIG. 2 is a flowchart showing a decision function for determining a location context of a smartphone when a user moves from outdoors to indoors; and

FIG. 3 is s flowchart showing a method according to embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Whilst the terms “indoors” and “outdoors” have their usual meanings it may be beneficial to define terms which link the user and smartphone to the same or similar location context. For example, a smartphone may be in a pocket and yet the user could be outdoors in a park: the smartphone may be considered as being in an indoors environment, but the user is an outdoors environment.

As used herein the term “contextually indoors” or more generally just “indoors” relates to any location or space that is sheltered, protected, or otherwise constructed so as to diminish, prevent, or block exposure of both a smartphone and smartphone user to potential sunlight. Examples of contextually indoors may be but are not limited to: the interior of a house; the interior of an automobile; and a subterranean transport network.

As used herein the term “contextually outdoors” or more generally just “outdoors” relates to any location or space that is open so as not to diminish, prevent, or block exposure of both a smartphone and smartphone user to potential sunlight. Examples of contextually outdoors may be but are not limited to: a park during the day; a beach at night; and on the deck of a boat at sunset.

As used herein the term “contextually deprived” relates to a state of a smartphone wherein the smartphone cannot make a determination based on light measurements alone as to whether a user of the smartphone is indoors or outdoors. I.e. the smartphone cannot determine between either of contextually indoors or contextually outdoors. Examples of situations where a smartphone may be contextually deprived include but are not limited to: when the smartphone is in a pocket; when the smartphone is in a handbag; and when the smartphone is face down on a hard surface, such that its light sensors are covered.

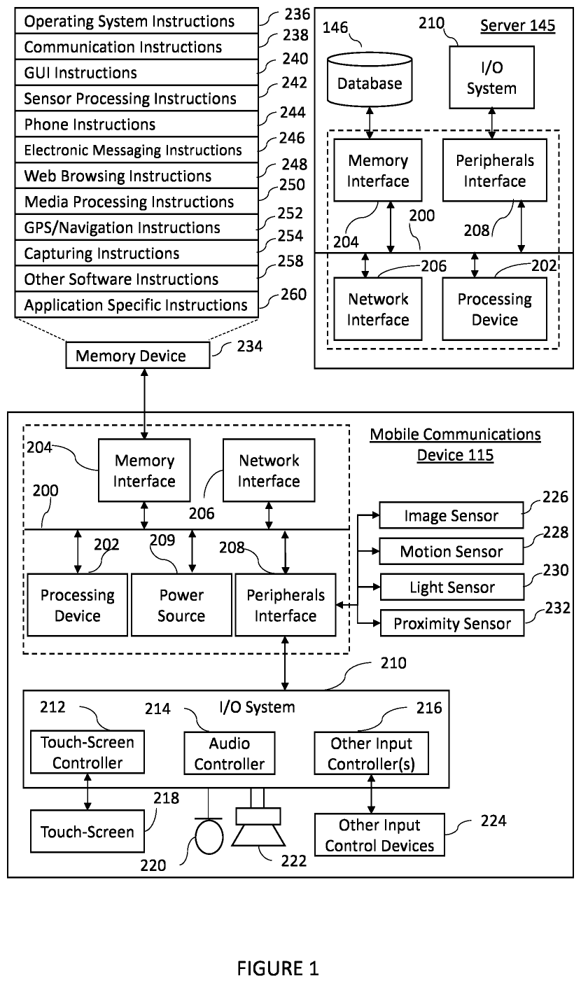

FIG. 1 shows an example architecture of a mobile communications device 115 such as a smartphone. Mobile communications device 115 comprises at least one motion sensor 228, and at least one light sensor 230 as part of a peripherals interface 208. Mobile communications device 115 also comprises at least one microphone 220. Instructions for carrying out methods in accordance with embodiments of the present invention may be stored in memory device 234 of mobile communications device 115 to be implemented by a processing device 202.

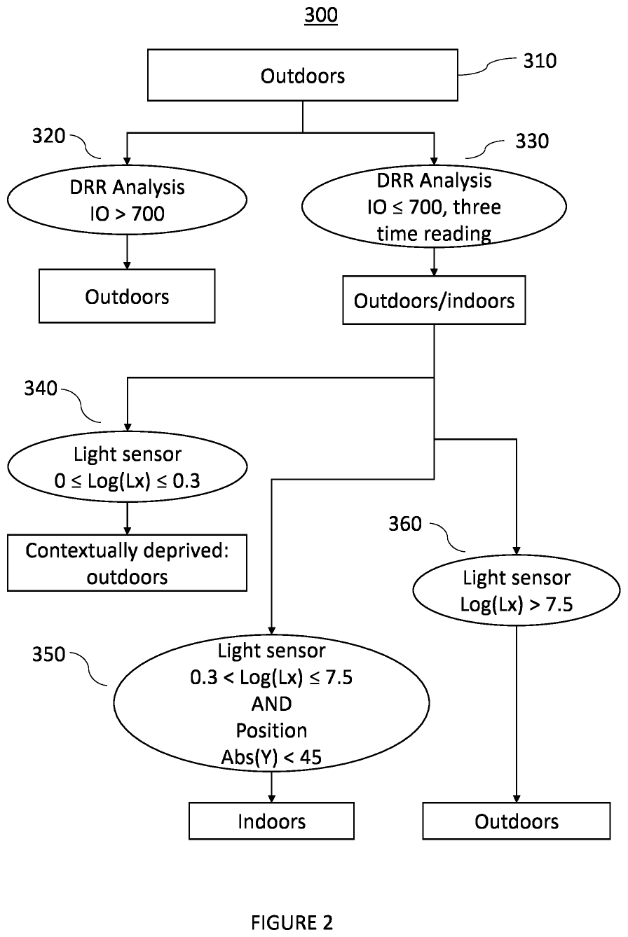

FIG. 2 shows a decision function 300 that may be carried out by a smartphone such as mobile communications device 115.

A DRR analysis may be performed as a first stage, using data measured by microphone 220 to determine an IO of the smartphone.

As shown in step 320, if IO>700 then the decision function determines that the smartphone is outdoors.

Alternatively, as shown in step 330, if IO≤700 and is measured to be so on at least three occasions, then the decision function determines that the smartphone may be transitioning between outdoors and indoors and requires further information from other sensors to make a decision. The decision function then moves to a second stage, comparing at least one of light intensity data and acceleration data to a given range.

Light sensor 230 may be part of a front or back camera of mobile communications device 115. Light sensor 230 may measure and record a light intensity “Lx”. Measurements from light sensor 230 may be used in a decision function to determine a location context of mobile communications device 115. By comparing the measured light intensity to a predetermined range a decision can be made as to the location context of the mobile communications device 115.

As shown in step 340, if 0≤Log(Lx)≤0.3 then the decision function may determine that the smartphone is contextually deprived, but determine that the user is nonetheless outdoors.

As shown in step 360, if Log(Lx)>7.5 then the decision function may determine that the smartphone is contextually outdoors.

Measurements from the at least one motion sensor 228 may also be used to determine a location context of the smartphone. Measurements from motion sensor 228 may take the form (X, Y, Z) for a position of the smartphone and (U, V, W) for an acceleration of the smartphone.

Measurements from motion sensor 228 may be used in conjunction with measurements from light sensor 230 to determine a location context of the smartphone.

For example, if 0.3≤Log(Lx)≤7.5 and abs(Y)<45 then the decision function may determine that the smartphone is indoors, as shown in step 350 of FIG. 2.

When no acceleration data is recorded the decision function may determine that the smartphone is on a surface.

A given combination of light and motion data recorded by the respective sensors of the smartphone may be used by the decision function to determine that the smartphone is in a pocket or handbag, an example of a contextually deprived situation.

Movement sensors in the smartphone, such as motion sensor 228, may also provide data that enables the decision function to make enhanced location context determinations.

For example if a measured speed is greater than a given alpha and less than a given beta, it may be determined that the user is outdoors and walking. Similarly, if a measured speed is greater than beta it may be determined that the smartphone and user are travelling in a vehicle, an example of a contextually indoors situation.

Based on measurements of acceleration it may be possible to distinguish whether the user and smartphone are travelling in an automobile such as a car, or whether the user is travelling on a bicycle. The latter situation would be an example of a contextually outdoors situation.

The decision function may use a hierarchy of sensors and sensor data to determine a location context of the smartphone. Such a hierarchy may be as follows: Acceleration sensors; Light sensor; Microphone; Time; Position; and Geolocation.

The decision function may also use Wi-Fi to determine a location context of the smartphone. For example, a high signal strength of a wireless network may indicate proximity to the router and suggest that the smartphone, and by extension the user, is indoors.

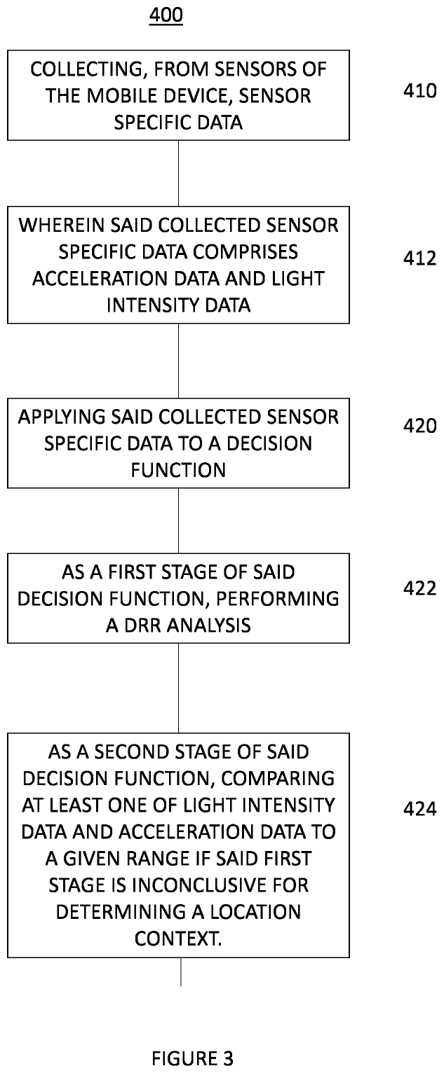

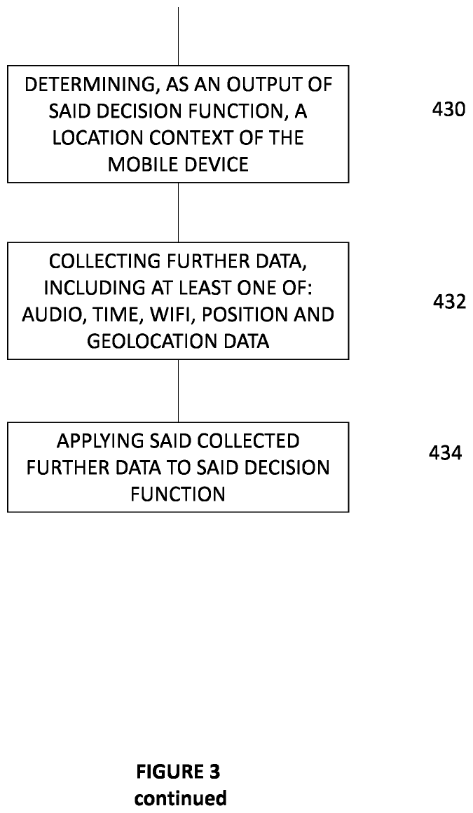

FIG. 3 shows a method 400 for determining a location context of a mobile device such as a smartphone or mobile communications device 115.

Method 400 comprises step 410 of collecting, from sensors of the mobile device, sensor specific data.

Sensors of the mobile device may be the aforementioned motion sensor 228, light sensor 230 or other sensors of peripherals interface 208 of mobile communications device 115. Microphone 220 of mobile communications device 115 may also be such a sensor.

Sensor specific data is data collected, measured, or recorded from a specific sensor of the mobile device. As described in step 412, the sensor specific data comprises acceleration data and light intensity data. The data is sensor specific in that, for example: light intensity data is sensor specific data which is collected by light sensor 230, and acceleration data is sensor specific data which is collected by motion sensor 228.

Method 400 further comprises step 420 of applying said collected sensor specific data to a decision function. The decision function may be one such as illustrated in FIG. 2.

Step 422 of method 400 comprises as a first stage of said decision function, performing a DRR analysis.

Step 424 of method 400 comprises as a second stage of said decision function, comparing at least one of light intensity data and acceleration data to a given range if said first stage is inconclusive for determining a location context. This step can be seen functionally in step 330 of decision function 300.

Method 400 includes also step 430 of determining, as an output of said decision function, a location context of the mobile device.

Method 400 may optionally include step 432 of collecting further data, including at least one of: audio, time, Wi-Fi, position and geolocation data and subsequent step 434 of applying said collected further data to said decision function. Such further data may be received from other units of the mobile device, for example from network interface 206 of mobile communications device 115.

As discussed previously, and applicable here to method 400, part of the output of the decision function may be a determination of a type of platform the mobile device or smartphone may be in contact with. For example, the smartphone may be face down on a table or inside a pocket. These situations are contextually deprived situations for the smartphone. Determination of a platform may also comprise determining if the user and smartphone are travelling in an automobile or on a bicycle, for example.

Also as discussed previously, method 400 may determine a location context to be used as part of a personal ultraviolet light monitoring application.

In accordance with embodiments of the present invention, a non-transitory computer readable medium may include a set of instructions that when executed cause at least one processor to perform method 400. The processor may be processing device 202 of mobile communications device 115, for example.

In order to implement the method according to embodiments of the present invention, a computer processor may receive instructions and data from a read-only memory or a random access memory or both. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in base band or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or sersver. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

1. A method for determining a location context of a mobile device, the method comprising:
collecting, from sensors of the mobile device, sensor specific data;
applying said collected sensor specific data to a decision function; and
determining, as an output of said decision function, a location context of the mobile device,
wherein said collected sensor specific data comprises acceleration data and light intensity data, and
wherein said decision function comprises:
a first stage of performing a DRR analysis; and
a second stage of comparing at least one of light intensity data and acceleration data to a given range if said first stage is inconclusive for determining a location context.

2. The method of claim 1, wherein further data is collected from other units of the mobile device, said further data including at least one of: audio, time, Wi-Fi, position and geolocation data, and
wherein said collected further data is applied to said decision function to determine a location context of the mobile device.

3. The method of claim 2, wherein the output of said decision function is a type of platform the mobile device may be in contact with.

4. The method of claim 1, wherein the decision function determines the mobile device to be outdoors if said first stage DRR analysis is such that IO>700.

5. The method of claim 1, wherein the decision function moves to said second stage if said first stage DRR analysis is such that IO≤700 and is measured to be so on three occasions.

6. The method of claim 1, wherein the decision function determines the mobile device to be outdoors but covered if a light intensity “Lx” collected by a sensor of the mobile device is such that 0≤log(Lx)≤0.3.

7. The method of claim 1, wherein the decision function determines the mobile device to be outdoors if a light intensity “Lx” collected by a sensor of the mobile device is such that log(Lx)>7.5.

8. The method of claim 1 wherein the decision function determines the mobile device to be indoors if both light intensity “Lx” collected by a sensor of the mobile device is such that 0.3<log(Lx)≤7.5 and a component of acceleration “Y” is such that abs(Y)<45.

9. The method of claim 1, wherein acceleration data is used by said decision function to determine if a user of the mobile device is:
travelling on foot;
travelling on a bicycle; and
travelling in an automobile,
so that said decision function can determine a location context of the user and mobile device.

10. The method of claim 1, wherein the determined location context is used as part of a personal ultraviolet light monitoring application.

11. A system for determining a location context of a mobile device, the method comprising:
sensors of the mobile device configured to collect sensor specific data;
a computer processor configured to:
apply said collected sensor specific data to a decision function; and
determining, as an output of said decision function, a location context of the mobile device,
wherein said collected sensor specific data comprises acceleration data and light intensity data, and
wherein said decision function comprises: a first stage of performing a DRR analysis; and a second stage of comparing at least one of light intensity data and acceleration data to a given range if said first stage is inconclusive for determining a location context.

12. The system of claim 11, wherein further data is collected from other units of the mobile device, said further data including at least one of: audio, time, Wi-Fi, position and geolocation data, and
wherein said collected further data is applied to said decision function to determine a location context of the mobile device.

13. The system of claim 12, wherein the output of said decision function is a type of platform the mobile device may be in contact with.

14. The system of claim 11, wherein the decision function determines the mobile device to be outdoors if said first stage DRR analysis is such that IO>700.

15. The system of claim 11, wherein the decision function moves to said second stage if said first stage DRR analysis is such that IO≤700 and is measured to be so on three occasions.

16. The system of claim 11, wherein the decision function determines the mobile device to be outdoors but covered if a light intensity “Lx” collected by a sensor of the mobile device is such that 0≤log(Lx)≤0.3.

17. The system of claim 11, wherein the decision function determines the mobile device to be outdoors if a light intensity “Lx” collected by a sensor of the mobile device is such that log(Lx)>7.5.

18. The system of claim 11, wherein the decision function determines the mobile device to be indoors if both light intensity “Lx” collected by a sensor of the mobile device is such that 0.3<log(Lx)≤7.5 and a component of acceleration “Y” is such that abs(Y)<45.

19. The system of claim 11, wherein acceleration data is used by said decision function to determine if a user of the mobile device is: travelling on foot; travelling on a bicycle; and travelling in an automobile, so that said decision function can determine a location context of the user and mobile device.

20. The system of claim 11, wherein the determined location context is used as part of a personal ultraviolet light monitoring application.
